(19) United States
(12) Patent Application Publication
(10) Pub. No.: US 2011/0192124 A1
(43) Pub. Date: Aug. 11, 2011

(54) DUST COLLECTOR

(76) Inventor: Tony LIN, Taichung City (TW)

(21) Appl. No.: 12/704,520

(22) Filed: Feb. 11, 2010

(51) Int. Cl. B01D 46/42

(52) U.S. Cl. 55/383

(57) ABSTRACT

The dust collector of the present invention includes a main body and a hanging device. The main body includes a shell, a dust container, a sieve element and a suction device. The shell defines a first chamber and a second chamber therein, and the shell is formed with an inlet and an outlet. The inlet communicates with the first chamber, and the outlet communicates with the second chamber. The dust container defines a receiving space communicated with the first chamber, and the dust container stands on a ground surface. The sieve element is disposed on the outlet. The suction device is adapted to draw air from the first chamber into the second chamber. The hanging device is adapted to hang the shell on a wall. As such, the dust collector will be steadily positioned.

### BACKGROUND OF THE INVENTION

1. Field of the Invention

The present invention relates to a dust collector.

2. Description of the Prior Art

Conventional dust collectors as disclosed in TW M333944 and TW M336816 are mainly used to clean the air. Specifically, they both disclose a dust collect including a suction device to draw air into the dust collector, and the suspension dust in the air will precipitate in the dust collector. Two dust bags are further provided to receive the subsided dust therein.

However, such dust collector is heavy on the upper portion thereof due to the disposal of the suction device, thus it might be accidentally toppled.

The present invention is, therefore, arisen to obviate or at least mitigate the above-mentioned disadvantages.

### SUMMARY OF THE INVENTION

The main object of the present invention is to provide a steadily-positioned dust collector.

To achieve the above and other objects, a dust collector of the present invention includes a main body and a hanging device. The main body includes a sell, a dust container, a sieve element and a suction device. The shell defines a first chamber and a second chamber therein, and the shell is formed with an inlet and an outlet. The inlet communicates with the first chamber, and the outlet communicates with the second chamber. The dust container defines a receiving space communicated with the first chamber, and the dust container stands on a ground surface. The sieve element is disposed on the outlet. The suction device is adapted to draw air front the first chamber into the second chamber. The hanging device is adapted to hang the shell on a wall.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view showing a dust collector in accordance with a first embodiment of the present invention;

FIG. 2 is a schematic drawing showing a dust collector of the present invention;

FIG. 3 is a perspective view showing a dust collector in accordance with a second embodiment of the present invention.

### DETAILED DESCRIPTION OF THE PREFERRED EMBODIMENTS

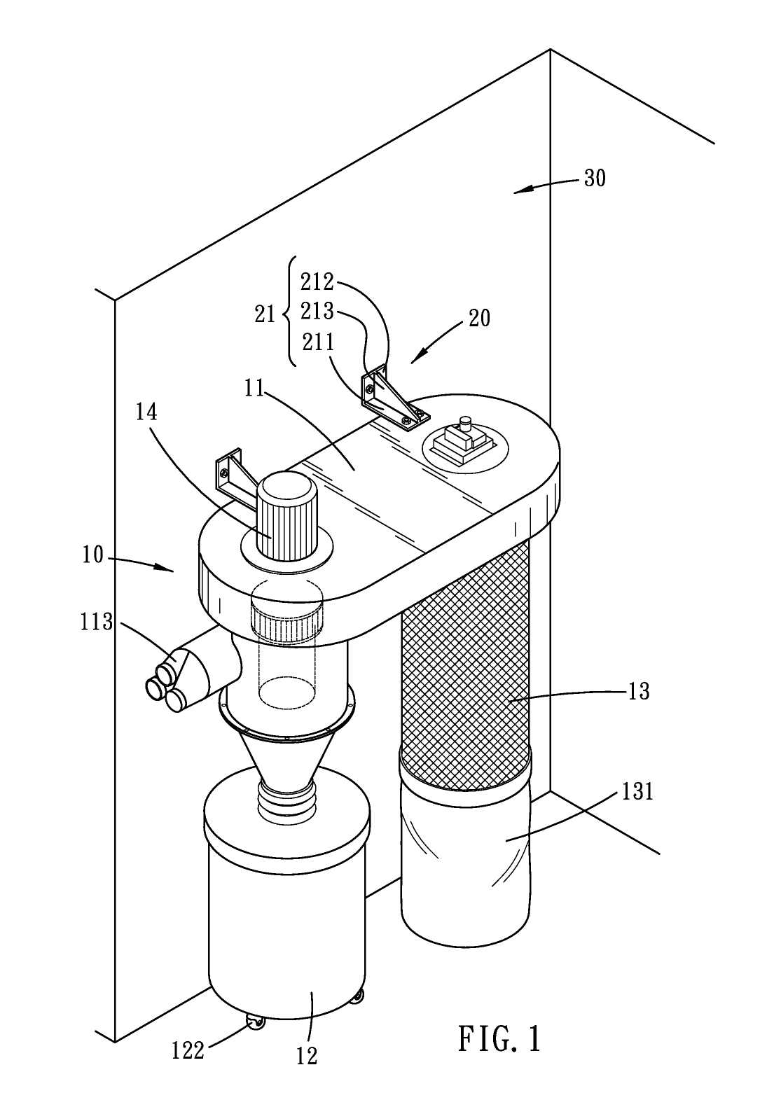

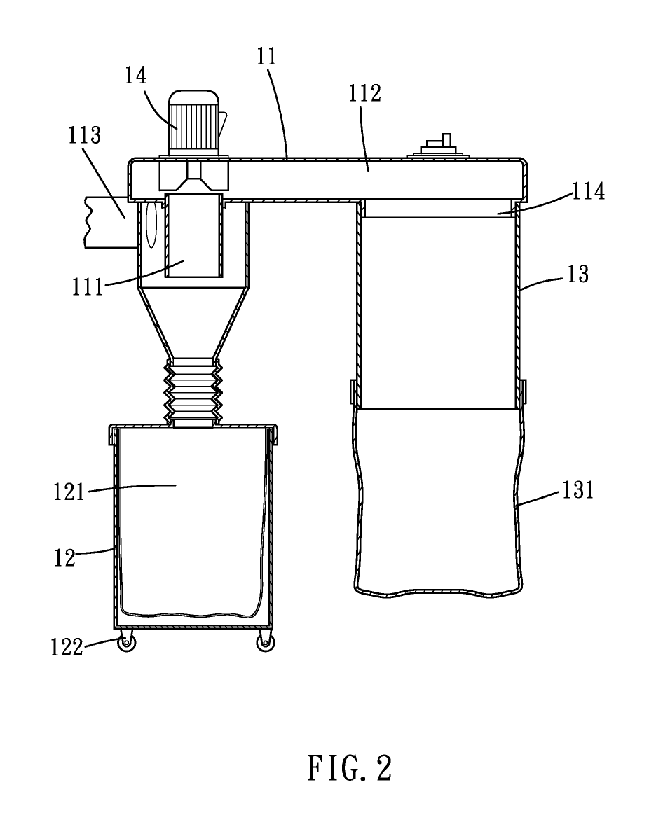

Please refer to FIGS. 1 and 2 for a first embodiment of the present invention. A dust collector includes a main body 10 and a hanging device 20.

The main body 10 includes a shell 11, a dust container 12, a sieve element 13 and a suction device 14. The shell 11 defines a first chamber 111 and a second chamber 112, and the shell 11 is formed with an inlet 113 and an outlet 114 (as best shown in FIG. 2). The inlet 113 communicates with the first chamber 111, and the outlet 114 communicates with the second chamber 112. Note that the inlet 113 of the present embodiment is provided with three adapters to connect with one or more pipes respectively. Also note that the first chamber 111 can be designed to have non-linear passage for the air to flow therein, so as to change the flow rate and direction of the air to increase the efficiency of dust subsidence. The dust container 12 is disposed beneath the shell 11 and defines a receiving space 121 communicated with the first chamber 111. The dust container 12 rests on a ground surface, and it may be further provided with several wheels 122. The sieve element 13 is disposed on the outlet 114 to finely filtrate the air. The sieve element 13 may be simply plate shaped, or it may be a cylindrical structure as shown in the present embodiment. Hence the cylindrical sieve element 13 defines a final condensing space therein, and a lower end thereof is attached with a bag 131 to gather the subsided dust. The suction device 14 is adapted to draw air from the first chamber 111 into the second chamber 112. Preferably, the suction device 14 includes a motor and a fan, which divides the shell into the first chamber 111 and the second chamber 112. As such, the air enters the first chamber 111 from the inlet 113, the dust will be roughly subsided in the first chamber 111 due to changes of the flow rate and direction. The subsided dust then falls into the dust collector 12. The pre-processed air is then drawn into the second chamber 112 by the suction device 14, and then it is filtered by the sieve element 13. Thus the filtered dust will fall into the bag 131. As a result, the air is well cleaned.

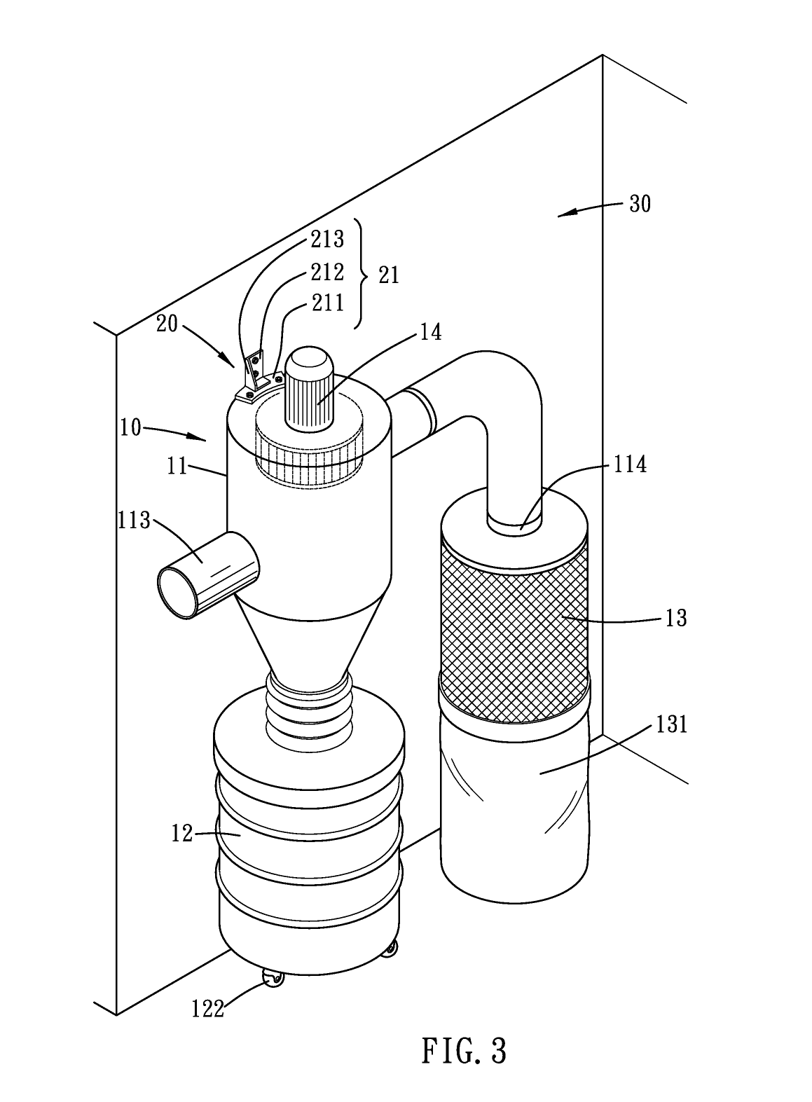

Please refer to FIG. 3 for the second embodiment of the present invention. A dust collector of the present embodiment is quite similar to that of the first embodiment, except that the inlet 113 is provided with only one opening, and that the second chamber 112 is defined in a tube-shaped portion of the shell 11.

The hanging device 20 is adapted to hang the shell 11 on a wall 30. Specifically, the hanging device 20 may include several fix elements 21, each includes a horizontal plate 211, a vertical plate 212 and a reinforce rib 213. The horizontal plate 211 and the vertical plate 212 connect to each other. The horizontal plate 211 is used to attach to the shell 11 in a threaded manner, in a welding manner or in other manners suitable, the vertical plate 212 is used to attach to the wall 30 in similar manner with the horizontal plate 211. The reinforce rib 213 is vertically extended from the horizontal plate 211 and perpendicular to the vertical plate 212 to enhance the mechanical strength of the hanging device 20. As such, the shell can be steadily positioned on the wall and will not be accidentally toppled. Also, the dust collector is not likely to slide along the ground surface despite the vibration of the motor of the suction device.

What is claimed is:

1. A dust collector, comprising:
a main body, comprising a shell, a dust container, a sieve element and a suction device, the shell defining a first chamber and a second chamber therein, and the shell being formed with an inlet and an outlet, the inlet communicating with the first chamber, and the outlet communicating with the second chamber, the dust container defining a receiving space communicated with the first chamber, the dust container resting on a ground surface, the sieve element being disposed on the outlet, the suction device being adapted to draw air from the first chamber into the second chamber;
a hanging device, being adapted to hang the shell on a wall.

2. The dust collector of claim 1, wherein the hanging device comprises several fix elements, each of the fix elements comprises a horizontal plate and a vertical plate connecting to the horizontal plate, the horizontal plate is attached to the shell, and the vertical plate is attached to the wall.

3. The dust collector of claim 2, wherein each of the fix elements further comprises a reinforce rib which is vertically extended from the horizontal plate and perpendicular to the vertical plate.
